(19) United States
(12) Patent Application Publication
(10) Pub. No.: US 2024/0393517 A1
(43) Pub. Date: Nov. 28, 2024

(54) In-Coupler For Near-Eye Display Waveguide Combiners

(71) Applicant: Meta Materials Inc., North Billerica, MA (US)

(72) Inventors: Ehsan Alimohammadian, Ottawa (CA); Milad Khoshnegar Shahrestani, Coquitlam (CA)

(21) Appl. No.: 18/674,737

(22) Filed: May 24, 2024

Related U.S. Application Data
(60) Provisional application No. 63/468,771, filed on May 24, 2023.

(51) Int. Cl. F21V 8/00

(52) U.S. Cl. CPC G02B 6/0016; G02B 6/0018; G02B 6/0065

(57) ABSTRACT

A display and waveguide system includes an in-coupler, an out-coupler, a light engine, and a waveguide core. The in-coupler is a combination of a refractive element (for example, an angled microfacet) and a diffractive element (for example, a grating). This microfacet, which uses refraction to change the light direction, is combined with the grating, which uses diffraction to change the light direction, for a combination that enables a large steering angle with high-efficiency coupling. The in-coupler structure in one example includes a layer of dielectric material, into which the refractive and diffractive elements are embossed using a nanoimprinting stamp. The embossed dielectric surface can be covered with a protective layer of protective material.

### CROSS REFERENCE TO RELATED APPLICATION

This application claims the benefit under 35 U.S.C. § 119 (e) from U.S. Provisional Application No. 63/468,771, entitled “In-Coupler For Near-Eye Display Waveguide Combiners,” filed on May 24, 2023. The entirety of the disclosure of the foregoing document is incorporated herein by reference.

### TECHNICAL FIELD

The present disclosure is in the field of optics, and more specifically, to input grating couplers for waveguide-based combiners.

### BACKGROUND INFORMATION

Near-eye display systems serve an important function in head-mounted display (HMD) and head-up display (HUD) technologies. A component in waveguide-based near-eye display systems is the coupling and steering element, which can be made using different technologies including surface relief gratings (SRG). Grating structures in an SRG can be used for in-coupling light from a light engine into a waveguide combiner. Grating structures can be used to change the propagation direction (i.e., the optical axis) of the light emitted from the light engine, thereby allowing high-efficiency coupling into the waveguide combiner.

There are various types of grating, which can be incorporated into the body of waveguide combiners to function as the in-couplers and out-couplers. These in-couplers and out-couplers can operate in either transmission or reflection modes. Among these, binary gratings suffer from low efficiency of the fundamental mode in both transmission and reflection modes, and blazed gratings suffer with respect to fabrication sensitivity.

Several factors affect the performance of the in-couplers, including, e.g., the optical refractive index, haze, and production costs. These factors are useful design considerations in selecting the material for fabricating couplers and waveguide components. For example, the total internal reflection (TIR) condition can present a challenge with respect to coupling efficiency for diffractive in-couplers. When there is a low contrast between the refractive indices of the core of the waveguide and the surrounding medium (e.g., but not limited to, the cladding), the TIR condition can require a large steering angle for the diffractive in-coupler. But a large steering angle for the diffractive in-coupler can result in poor coupling efficiency, whereas improved coupling efficiency can be achieved if the diffraction angle was smaller.

Further, the poor coupling efficiency corresponding to the large diffraction can lead to high-power consumption. This design challenge has a large impact for thin and small footprint implementation of the system sandwiched between the supporting and protective media.

Practical considerations make waveguide with low contrast refractive indices desirable form a manufacturing perspective. With the existing library of castable and nanoimprint-friendly materials (viscosity, shrinkage, wettability, and curing time), it can be challenging to obtain a sufficiently large refractive index contrast to simultaneously satisfy both coupling efficiency requirements and the TIR condition using existing in-couplers. When the refractive index contrast between core and cladding in a waveguide is small (e.g., but not limited to Δn<0.2), the total internal reflection (TIR) angle θTIR is large (e.g., but not limited to θTIR>60 degrees). But an in-coupler having a commensurate large steering angle can be inefficient.

Consequently, for in-coupling system that includes a grating and a waveguide, the refractive index contrast of the grating and waveguide with respect to the surrounding medium may be insufficient to enable a sufficiently large steering angle that can simultaneously satisfy the TIR condition while also providing high coupling efficiency (e.g., but not limited, 40% efficiency). Compensating for poor coupling efficiency can lead to devices having high-power consumption. The design challenge arising from low contrast between the refractive indices can be more difficult to overcome for thin and small footprint implementations that are sandwiched between the supporting and protective media (e.g., but not limited to, cladding a protection layers).

Therefore, what is needed is an improved in-coupler that addresses the aforementioned issues.

### SUMMARY

It has been discovered that refractive microstructures combined with a nanostructured diffraction grating provide larger steering/deflection angles (i.e., the change in the optical axis due to the in-coupler) while maintaining high-efficiency coupling into the waveguide.

This discovery has been exploited to develop the present disclosure, which, in part, is directed to in-couplers that can be used in waveguide-based near-eye display systems.

In one aspect, the present disclosure is directed to an in-coupler device, that includes a waveguide that has a core having a first index of refraction, the core being adjacent to a neighboring medium having a second index of refraction that is less than the first index of refraction. The in-coupler device also includes an in-coupling component comprising a diffractive element and a refractive element. The diffractive element uses diffraction to induce a first change in a direction of an optical axis of incoming light. The refractive component uses refraction to induce a second change in the direction of the optical axis of the incoming light.

In an example, which may be combined with any of the examples in the present disclosure, a combination of the first change and the second change changes the direction of the incoming light by a steering angle that couples the incoming light into the waveguide.

In another example, which may be combined with any of the examples in the present disclosure, the diffractive element comprises a transmissive diffraction grating with a pitch d.

In yet another example, which may be combined with any of the examples in the present disclosure, the transmissive diffraction grating comprises a surface relief grating having nanostructures that vary an index of refraction with the pitch d.

In still another example, which may be combined with any of the examples in the present disclosure, the pitch d is between about 300 nm and about 1000 nm.

In an additional example, which may be combined with any of the examples in the present disclosure, the refractive element comprises an array of microfacets that are dielectric wedges with a characteristic length D that is at least twice as large as the pitch d of the diffractive element.

In an example, which may be combined with any of the examples in the present disclosure, the pitch d is between about 300 nm and about 1000 nm, a duty cycle of the transmissive diffraction grating is between about 30% and about 80%; and the characteristic length D is between about 1 μm and about 72 μm.

In another example, which may be combined with any of the examples in the present disclosure, the pitch d is between about 400 nm and about 700 nm and the characteristic length D is between about 4 μm and about 64 μm.

In yet another example, which may be combined with any of the examples in the present disclosure, a wedge angle of the microfacets is between about 5 degrees and about 60 degrees.

In still another example, which may be combined with any of the examples in the present disclosure, the surface relief grating is provided by a periodic grating structure etched in a dielectric on a face of the refractive element and the periodic grating structure is a slanted grating with a slant angle between about 20 degrees and about 70 degrees with respective to the face of the refractive element.

In an additional example, which may be combined with any of the examples in the present disclosure, the first change in the direction of the optical axis is greater for longer visible wavelengths than for shorter visible wavelengths and the second change in the direction of the optical axis is less for longer visible wavelengths than for shorter visible wavelengths.

In another aspect, a method of making an in-coupler device that comprises a waveguide with a core, a refractive element, and a diffractive element includes providing a core of a waveguide, the core having a first index of refraction and being adjacent to a neighboring medium having a second index of refraction that is less than the first index of refraction. The method also includes providing a stamp comprising a microstructure and a nanostructure, the microstructure having a shape of a refractive element of an in-coupling component, and the nanostructure having a shape of a diffractive element of the in-coupling component. The method further includes arranging an in-coupler medium adjacent to at least a portion of the core. Additionally, the method includes stamping the in-coupler medium with the stamp to imprint a shape of the stamp on the in-coupler medium, thereby providing the in-coupler device.

In a further example, which may be combined with any of the examples in the present disclosure, the method further includes fabricating the stamp by patterning a resist coating on a substrate to generate a coated substrate, etching the coated substrate to transfer a pattern of the patterned resist coating to generate the microstructure on a surface of the substrate, forming a mask on the microstructured surface of the substrate, the mask having openings that expose the substrate, and etching the substrate at the openings in the mask to form the nanostructure within the microstructured surface.

In another example, which may be combined with any of the examples in the present disclosure, fabricating the stamp further comprises shaping the microstructure on the surface of the substrate to be a negative of microfacets in the in-coupling component, the microstructure being shaped by using gray-scale electron beam lithography to pattern profile shape (e.g., but not limited to, a saw-tooth shape or a piecewise monotonic shape) in the resist, reflowing the resist coating to smooth a surface profile of the profile shape to generate the patterned resist, and etching the patterned resist coating using an anisotropic dry etching process that transfers the profile shape of the patterned resist coating to the substrate, thereby generating a negative of shape of microfacet to be formed in the in-coupling component.

In yet another example, which may be combined with any of the examples in the present disclosure, the in-coupler medium, when stamped with the stamp forms an in-coupling component comprising the diffractive element and the refractive element, the diffractive element uses diffraction to induce a first change in a direction of an optical axis of incoming light, and the refractive element uses refraction to induce a second change in the direction of the optical axis of the incoming light.

In still another example, which may be combined with any of the examples in the present disclosure, a combination of the first change with the second change changes the direction of the incoming light by a steering angle that couples the incoming light into the waveguide such that a total internal reflection (TIR) condition of the waveguide is satisfied, and the TIR condition depends on a contrast between the first index of refraction and the second index of refraction.

In an additional example, which may be combined with any of the examples in the present disclosure, the diffractive element comprises a surface relief grating comprising nanostructures that vary an index of refraction with a pitch d.

In a further example, which may be combined with any of the examples in the present disclosure, the refractive element comprises an array of microfacets that are dielectric wedges with a characteristic length D that is at least twice as large as the pitch d of the diffractive element.

In a still further example, which may be combined with any of the examples in the present disclosure, the pitch d is between about 400 nm and about 700 nm, a duty cycle of the surface relief grating is between about 30% and about 80%; and the characteristic length D is between about 4 μm and about 64 μm.

In another example, which may be combined with any of the examples in the present disclosure, the surface relief grating is provided by a periodic grating structure in a dielectric on a face of the refractive element, and the periodic grating structure is a slanted grating with a slant angle between about 20 degrees and about 70 degrees with respective to the face of the refractive element.

In still another aspect, method for designing and manufacturing the in-coupler device of any one aforementioned examples includes selecting material properties of the core and the neighboring medium of the waveguide and one more wavelengths of light guided by the waveguide. The method also includes calculating a steering angle using the selected material properties and the one more wavelengths, the steering angle satisfying a total internal reflection (TIR) condition. In addition, the method includes selecting a value for a pitch of the diffractive element and a value for a facet angle of the refractive element. The method further includes adjusting, based on results of iterative simulations, the values of the pitch and the facet angle to optimize a coupling efficiency while satisfying TIR condition. The method also includes manufacturing the in-coupler device according to the adjusted values of the pitch and the facet angle.

In yet another aspect, a method of using the in-coupler device of any one of the aforementioned examples includes coupling light from a light engine through the in-coupler device into an image-display portion to generate one of a head-mounted display (HMD) and head-up display (HUD).

Further details and embodiments and methods and techniques are described in the detailed description below. This summary does not purport to define the invention. The invention is defined by the claims.

### DESCRIPTION OF THE DRAWINGS

The foregoing and other objects of the present disclosure, the various features thereof, as well as the disclosure itself may be more fully understood from the following description, when read together with the accompanying drawings in which:

FIG. 1 is a diagram of a near-eye display system 100 in accordance with certain embodiments of the disclosure; the diagram shows how an image generated by a light engine 106 (including red, green, and blue rays) is guided to the desired imaging plane;

FIG. 2A is a schematic representation of guiding red light using a prior-art in-coupler;

FIG. 2B is a schematic representation of guiding green light using a prior-art in-coupler;

FIG. 2C is a schematic representation of guiding blue light using a prior-art in-coupler;

FIG. 3A is a schematic representation of guiding red light using an in-coupler with microfacets, in accordance with certain embodiments of the disclosure;

FIG. 3B is a schematic representation of guiding green light using the in-coupler with microfacets, in accordance with certain embodiments of the disclosure;

FIG. 3C is a schematic representation of guiding blue light using the in-coupler with microfacets, in accordance with certain embodiments of the disclosure;

FIG. 4A is a schematic representation of a waveguide combiner with an out-coupler and an in-coupler without microfacets, in accordance with certain embodiments of the disclosure;

FIG. 4B is a schematic representation of a waveguide combiner with an out-coupler and an in-coupler without microfacets, in accordance with certain embodiments;

FIG. 5A is a schematic representation of a configurations of the waveguide system, in accordance with certain embodiments of the disclosure;

FIG. 5B is a schematic representation of another configuration of the waveguide system, in accordance with certain embodiments of the disclosure;

FIG. 5C is a schematic representation of another configuration of the waveguide system, in accordance with certain embodiments of the disclosure;

FIG. 5D is a schematic representation of another configuration of the waveguide system, in accordance with certain embodiments of the disclosure;

FIG. 5E is a schematic representation of another configuration of the waveguide system, in accordance with certain embodiments of the disclosure;

FIG. 6A is a diagrammatic representation of steps in a process for fabricating a stamp, in accordance with certain embodiments of the disclosure;

FIG. 6B is a flow chart of a process for fabricating the stamp, in accordance with certain embodiments; of the disclosure;

FIG. 7 is a schematic representation of a unit cell of an in-coupler with microfacets having a first orientation, in accordance with certain embodiments v;

FIG. 8 is a schematic representation of a unit cell of an in-coupler with microfacets having a second orientation, in accordance with certain embodiment vs;

FIG. 9 is a flow chart of a process for optimizing parameters of the in-coupler, in accordance with certain embodiments of the disclosure;

FIG. 10 is a graphic representation of calculations of total internal reflection (TIR) angles, in accordance with certain embodiments of the disclosure; and

FIG. 11 is a graphic representation of simulations of coupling efficiencies, in accordance with certain embodiments of the disclosure.

### DETAILED DESCRIPTION

The disclosures of any patents, patent applications, and publications herein are hereby incorporated by reference into this application in their entireties in order to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group, unless otherwise indicated.

As used herein, the articles “a” and “an” refer to one or to more than one (i.e., to at least one) of the grammatical object of the article. By way of example, “an element” means one element or more than one element. Furthermore, use of the term “including” as well as other forms, such as “include,” “includes,” and “included,” is not limiting.

As used herein, the term “about” is understood by persons of ordinary skill in the art and will vary to some extent on the context in which it is used. As used herein when referring to a measurable value such as an amount, a temporal duration, and the like, the term “about” is meant to encompass variations of ±20% or ±10%, including ±5%, ±1%, and ±0.1% from the specified value, as such variations are appropriate to perform the disclosed methods.

The term “waveguide” refers to a medium that guides and/or expands the light field generated by the light engine.

The term “in-coupler” refers to an optical component that couples the incoming light into the waveguide and enables low-loss propagation of the lighting according to a designed steering angle.

The term “light engine” refers to a component that generates the desired optical image. The device includes but is not limited to red, green, and blue laser sources, OLEDs, and micro-LEDs.

The term “out-coupler” refers to an optical component that projects the expanded image out of the waveguide into the desired imaging plane within the observer's field of view (FOV).

The term “RGB rays” refers to rays of red, green, and blue light. The RGB rays provide an image projected from the light engine.

The term “visible wavelengths” or “visible light” refers a range of wavelengths of light that can be seen by the human eye (e.g., but not limited to, 380 nm to 750 nm).

The present disclosure provides an in-coupler for a waveguide system and method of fabricating and using the same. A component in the waveguide-based near-eye display systems, such as head-mounted displays (HMD), head-up displays (HUD), is the in-coupler device that performs the functions of coupling and steering light from a light engine (e.g., but not limited to, LEDs corresponding to wavelengths for red, green, and blue light). The in-coupler device can be made using different technologies, including, e.g., but not limited to, SRG technologies. For SRGs, the direction of the optical axis of the emitted light from the light engine is deflected/steered using grating structures to diffract the light, enabling high efficiency coupling into a waveguide combiner.

The disclosed in-couplers provide greater flexibility in design for maintaining the diffraction/coupling efficiency while increasing the steering angle and without the need for a substantially large refractive index contrast. Further, the disclosed in-couplers improve coupling of light into the waveguide combiner, especially to improve coupling efficiency for devices having low refractive index contrast between the core and cladding layers of the waveguide. The disclosed in-couplers improve flexibility with respect to controlling the diffractive coupler's optical axis with respect to the incident light.

There are various types of grating, such as binary grating, blazed grating, and slanted grating, which can be incorporated into the body of waveguide combiners as the input and output couplers operating into either transmission or reflection modes. Some of these gratings have deficiencies. For example, binary gratings suffer from low efficiency of the fundamental mode in both transmission and reflection modes, and blazed gratings suffer with respect to fabrication sensitivity.

Relative to other types of gratings, SRGs have several benefits. For example, SRGs can be mass manufactured using high-throughput roll-to-roll processes enabled by nanoimprinting techniques. SRGs can be fabricated with slanted gratings. Slanted gratings provide tunability for spectral and angular bandwidths and provide high efficiency, making them a promising option for transmissive in-couplers for near-eye displays. Moreover, slanted gratings can be fabricated using high-efficiency, mass manufacturing techniques.

In-couplers can be fabricated using a diverse range of materials, which have their respective advantages and limitations. Among the significant material attributes to be considered when selecting fabrication materials are the optical refractive index, haze, and the material compatibility with low-cost mass production. These material attributes are design considerations in selecting the material for manufacturing.

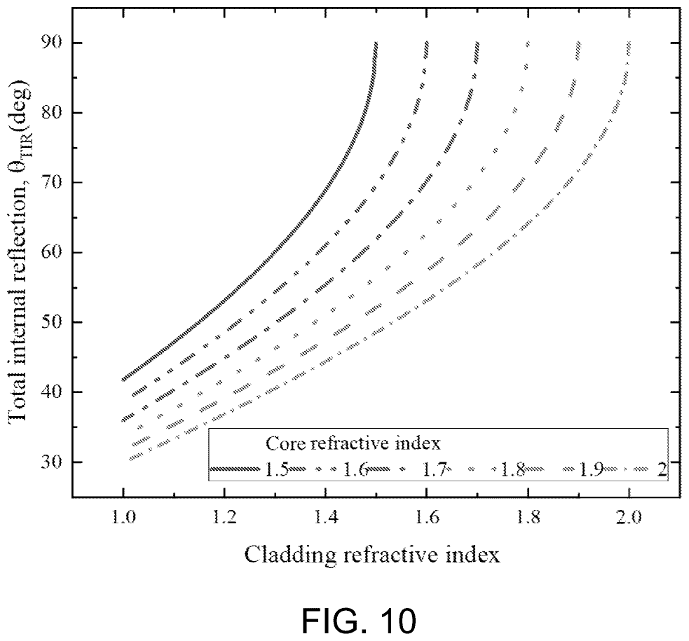

For example, the total internal reflection (TIR) condition is determined based on the refractive index contrast between the core and cladding layers of the waveguide. That is, the TIR angle STIR can be calculated using Snell's law:

$${θ}_{TIR} = {sin}^{- 1} ( \frac{{n}_{2}}{n 1} ) ,$$

where n₁ is the index of refraction of the cladding and n₂ is the index of refraction of the core. The TIR angle is the smallest angle at the core-cladding interface that prevents transmission through the interface. Thus, as the refractive index contrast decreases the TIR angle of incidence at the core-cladding interface increases, such that a small refractive index contrast (e.g., but not limited to Δn<0.2) results in a large TIR angle (e.g., but not limited to θ_{TIR}>60 degrees), as illustrated in FIG. 10. Achieving such a large incidence angle depends on the in-coupler creating a correspondingly large change in the direction of the optical axis (i.e., the deflection angle or steering angle), but such a large change in the direction of the optical axis can be challenging to realize efficiently using an SRG alone as the in-coupler.

Small refractive index contrast (e.g., but not limited to Δn<0.2) presents a design challenge with respect to simultaneously satisfying the TIR condition while also providing high coupling efficiency (e.g., but not limited, 40% efficiency). The in-couplers disclosed herein address this design challenge to facilitate practical implementations of near eye displays with the low refractive index contrast of materials that are available in the industry for efficient, cost-effective device fabrication.

According to certain examples, the steering angle satisfies the total internal reflection (TIR) condition inside the waveguide. For example, the in-coupler gratings can be used as beam steering elements, which use diffractive technologies that are based on surface relief (SRG) or volume holograms (VH). Available SRG elements include binary, blazed, and slanted grating. According to a non-limiting example, the present disclosure uses an in-coupler that combines SRG technologies together with refractive microstructures. Further, the SRG technologies can use slanted grating, but other grating structures can be used, as would be recognized by a person or ordinary skill in the art.

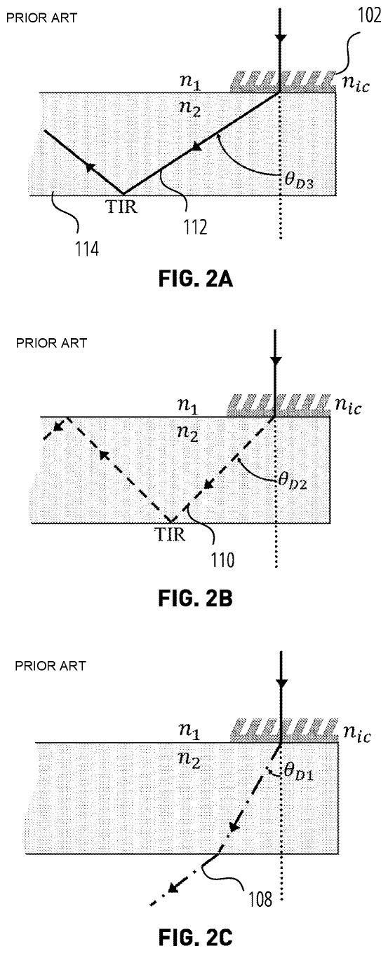

Efficient, cost-effective device fabrication can be performed using a range of castable and nanoimprint-friendly materials (e.g., but not limited to, materials having desirable properties with respective to viscosity, shrinkage, wettability, and curing time). These materials, however, present challenges with respect to providing a sufficiently large enough contrast between refractive indices to simultaneously satisfy the coupling-efficiency specifications and the total internal reflection (TIR) condition, as discussed below with respect to FIGS. 2A-2C. For example, depending on the near-eye display configuration and the optical path of the incident light, a trade off may exist between the coupling efficiency and satisfying the TIR condition, such that the coupling diffraction efficiency may be compromised to satisfy the TIR condition. The TIR condition is useful for the beam expansion and image reconstruction within the waveguide. Therefore, more flexibility in design that controls the diffractive coupler's optical axis with respect to the incident light may greatly assist in maintaining the diffraction/coupling efficiency without the need for a substantially large refractive index contrast between the SRG coupler and the supporting medium. The in-couplers disclosed herein provide this increased flexibility in design, and thereby improve the coupling efficiency without the need for a large refractive index contrast between the SRG coupler and the supporting medium.

The in-couplers disclosed herein include a refractive element (e.g., but not limited to, microfacets) that provide additional deflection/steering of the optical axis of the incoming light beyond that provided by the diffractive element (e.g., but not limited to, a transmissive diffraction grating such an SRG). By decreasing the deflection angle due to diffraction alone, the efficiency of the diffraction grating can be greater, resulting in improved coupling efficiency.

The in-couplers disclosed herein have several advantages over previous in-couplers. By adding microfacets underneath an optically efficient grating structure, the optical axis of the grating is changed with respect to the incident angle of the incoming light. The combination of the microfacet and the grating structure facilitates efficient beam steering by employing diffraction and refraction imposed by the grating and microfacet, respectively. Also, an SRG that is conformed to the microfacet structures adds another degree of freedom in designing efficient beam steering with a wider angular range, thereby improving control the beam's optical path inside the waveguide and ensuring the TIR condition is satisfied. Additionally, using microfacets facilitates the practical implementation of beam steering components with low-index contrast material configuration, enabling a wider range of possible low refractive index contrast materials for fabrication than was previously possible. Moreover, the in-couplers disclosed herein offer a practical approach to tune the slant angle with a higher perception and the top angle of the slanted grating.

As discussed above, the TIR angle, θTIR, is given by θTIR=sin−1 (n1/n2), where n2 is the index of refraction of the core and n1 is the index of refraction of the material surrounding the core (e.g., but not limited to the cladding). When the refractive index contrast is low between the core and cladding, the TIR angle θTIR is large, which limits the range of angles that satisfy the TIR condition along the waveguide. The in-couplers disclosed herein enables a degree of freedom that facilitates a steering/deflection angle that satisfies the TIR condition with higher efficiency than previously possible.

According to certain non-limiting examples, the in-couplers disclosed herein can be fabricated using a single-step method using replication imprinting from a single stamp that embeds all the micro and nanostructures, without the need to align the microstructures of microfacet and the nanostructures of the SRGs in separate replication sequences, thereby enabling high-throughput single-master production in plate-to-plate, roll-to-plate, and roll-to-roll nanoimprinting lithography techniques. Further, the stamp used for replication imprinting can be produced at the wafer scale using high-resolution lithography techniques (e.g., but not limited to, electron beam lithography).

Reference will now be made to specific examples illustrating the disclosure. It is to be understood that the examples are provided to illustrate exemplary embodiments and that no limitation to the scope of the disclosure is intended thereby.

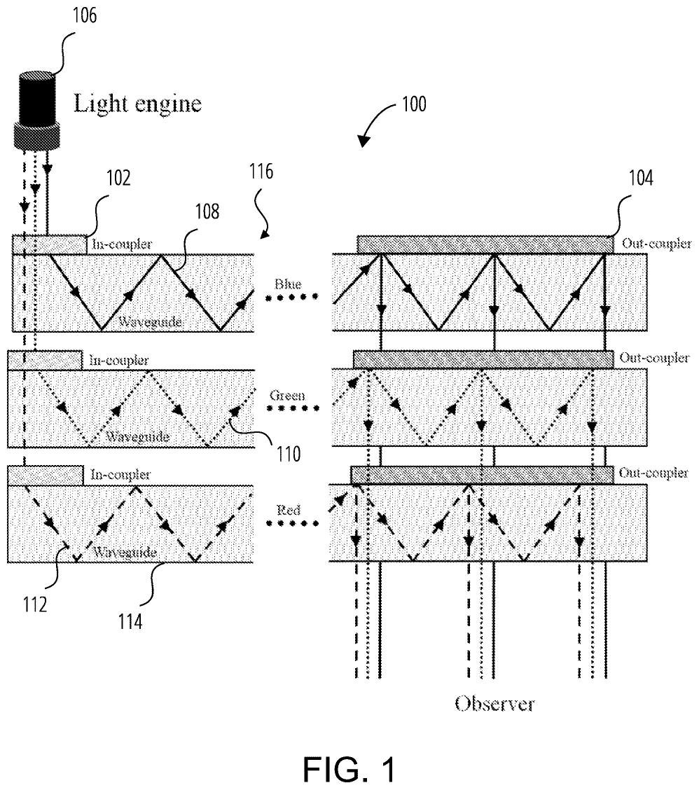

A non-limiting example of a display system 100 according to the disclosure is shown in FIG. 1. The display system 100 includes an in-coupler 102, an out-coupler 104, a light engine 106, and a waveguide core 114. The light engine 106 generates several rays of light including a blue light 108, a green light 110, and a red light 112. Each of these rays propagates from light engine 106 to the in-coupler 102 where the in-coupler 102 couples the incoming light into the core 114 of the waveguide 116, which may include cladding layers and protective layers around the core 114.

The guiding starts in the in-coupler 102 and ends in the out-coupler 104. The in-coupler 102 and out-coupler 104 can be designed in transmission or reflection mode. In the non-limiting example illustrated in FIG. 1, the in-coupler 102 works in transmission mode and the out-coupler 104 works in reflection mode. Generally, the waveguide and other components in the field of view of the operator (i.e., the operator's eye) are transparent with a minimum haze value of about 0.1% or lower.

According to certain non-limiting examples, the waveguide 116 is a combination of media that guides and/or expands the light generated by the light engine 106. The guiding starts at the in-coupler 102 and ends in the out-coupler 104. The in-coupler 102 and out-coupler 104 are components that can operate either in transmission mode or reflection mode. For the example illustrated in FIG. 1, the in-coupler 102 operates in transmission mode and the out-coupler 104 operates in reflection mode. The waveguide 116 and other components in the field of view (FOV) of the observer may be transparent with a minimum haze value of about 0.1% or lower.

According to certain non-limiting examples, the in-coupler 102 is an optical component that couples the incoming light into the core 114 of the waveguide 116. The in-coupler 102 further enables low-loss propagation of the light by steering/deflecting the incoming light according to a steering angle that satisfies the TIR condition of the waveguide 116. According to certain non-limiting examples, the in-coupler 102 includes a diffractive element (e.g., but not limited to, diffraction gratings) that are primarily responsible for steering the beam. For example, the diffractive element can use diffractive technologies that are based on surface relief gratings (SRG) or volume holograms gratings. Available SRG elements include binary, blazed, and slanted grating. The in-couplers disclosed herein are illustrated using SRG technologies for the diffractive element, and, more particularly, the SRG-based diffractive elements are illustrated using slanted grating. But other technologies and other grating structures can be used to provide the diffractive elements in the in-coupler 102.

According to certain non-limiting examples, the light engine 106 generates a desired optical image. The light engine 106 can be, e.g., but is not limited to, laser sources, organic light emitting diodes (OLEDs), and micro-LEDs.

According to certain non-limiting examples, the out-coupler 104 couples the light out from the waveguide 116, projecting the expanded image from the waveguide into an imaging plane within the observer's field of view (FOV).

Red, green, and blue (RGB) rays include the blue light 108, a green light 110, and a red light 112 that make up the image projected from the light engine.

In-coupling is illustrated for red, green, and blue wavelengths, respectively, in FIGS. 2A, 2B, and 2C. Assuming normal incidence for the incoming light, the diffraction angle θ_{D} for first order diffraction and pitch d is given by

$${θ}_{D} = {sin}^{- 1} ( \frac{{n}_{ic} λ}{d} ) ,$$

where n_{ic} is the index of refraction of the in-coupler 102 and λ is the wavelength. Thus, the diffraction angle θ_{D} is larger for longer wavelengths (e.g., but not limited to, red light 112) than for shorter wavelengths (e.g., but not limited to, blue light 108). This affect is illustrated by comparing FIG. 2A with FIG. 2C, in which comparison it can be observed that the diffraction angle θ_{D3} for the red light 112 is greater than the diffraction angle θ_{D1} for the blue light 108. In this non-limiting example, the diffraction angles θ_{D3} and θ_{D2} for the red light 112 and green light 110 satisfy the TIR condition, but the diffraction angle θ_{D1} for the blue light 108 fails the TIR condition. Thus, additional deflection/steering is used for the blue light 108 to satisfy the TIR condition.

Returning to FIG. 2A, a simplified schematic of a waveguide 116 is shown, illustrating the light guiding/steering concept for the in-coupling and guiding technologies. The incoming beam is steered using a diffractive optical element (i.e., in-coupler 102), which is illustrated as including binary, blazed, and slanted gratings.

The in-couplers disclosed herein are illustrated using the non-limiting example of transmissive slanted grating, but the concept for in-couplers disclosed herein are not limited to this example and extended to other instances, such as reflective blazed grating couplers. Further, the non-limiting examples illustrate the concepts using a normal incidence angle, but the concepts disclosed herein also apply to non-normal incidence angles. For example, the innovation disclosed herein can be used with other incidence angles by adjusting the pitch value of the grating in accordance with the incidence angle.

The response of light at the in-coupler 102 for three different wavelengths is shown in FIGS. 2A-2C. The slanted grating of the in-coupler 102 diffracts three example rays, representing red, green, and blue light corresponding to those shown in FIG. 1. For improved functioning, the in-coupler grating deflects the incoming light to propagate along the waveguide at an angle satisfying the total internal reflection (TIR) condition. Moreover, the parameters of the system are selected to also satisfy the angular bandwidth specified for the display system and in accordance with the observers' field of view (FOV). As discussed above, the TIR angle can be calculated by employing Snell's law, i.e.,

$${θ}_{TIR} = {sin}^{- 1} ( \frac{{n}_{1}}{{n}_{2}} ) ,$$

where n₂ is the index of refraction of the core and n₁ is the index of refraction of the material surrounding the core (e.g., but not limited to, the cladding).

The change in the optical axis caused by the in-coupler 102 that is due to diffraction alone (i.e., diffraction angle θ_{D}) is illustrated in FIGS. 2A-2C for three different wavelengths. This example illustrates the benefit of using an in-coupler 102 that combines the diffractive element with a refractive element in the in-coupler 102 to achieve a larger change in the optical axis.

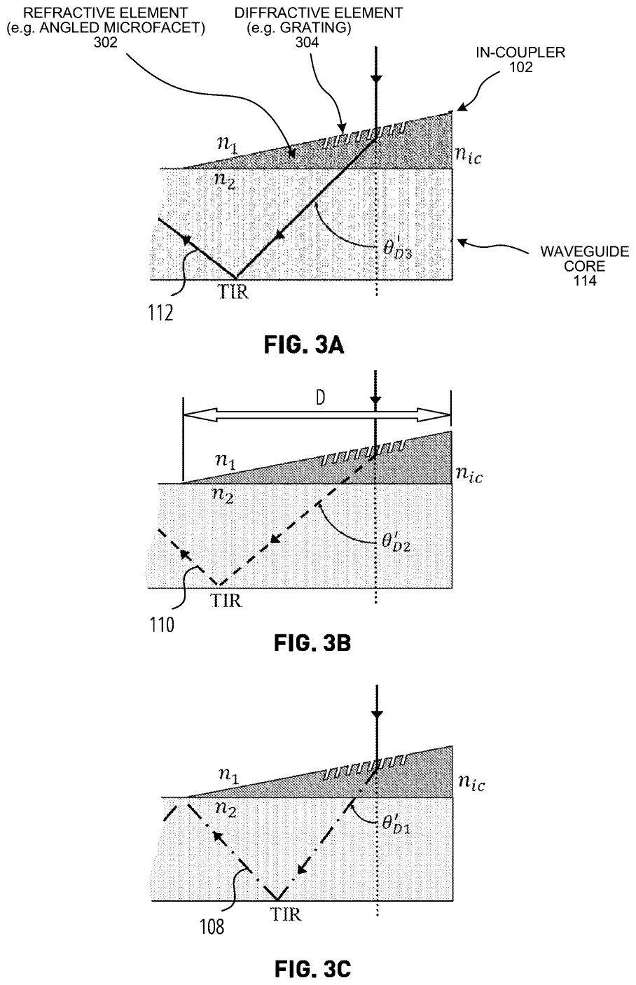

The change in the optical axis for red light 112 is shown in FIG. 2A. This shows an example for how a red wavelength ray can be steered by a slanted grating in-coupler 102 with a refractive index of n_{ic}. When index contrast between the core 114 and cladding is small (e.g., but not limited to, Δn=(n₂−n₁)<0.2) then the steering angle θ_{D3} is large (e.g., but not limited to, θ_{D3}>60 degrees) to satisfy the TIR condition. Increasing the steering angle θ_{D3} can be realized by increasing the refractive index n_{ic} for the in-coupler 102 (i.e., degreasing the wavelength in the medium) and/or by decreasing the pitch, d, for the slanted grating. An approach which avoids the decrease in coupling efficiency corresponding to and increased diffraction angle, is to increase the steering angle θ_{D3} without changing the diffraction angle, as discussed below, with reference to FIGS. 3A-3C.

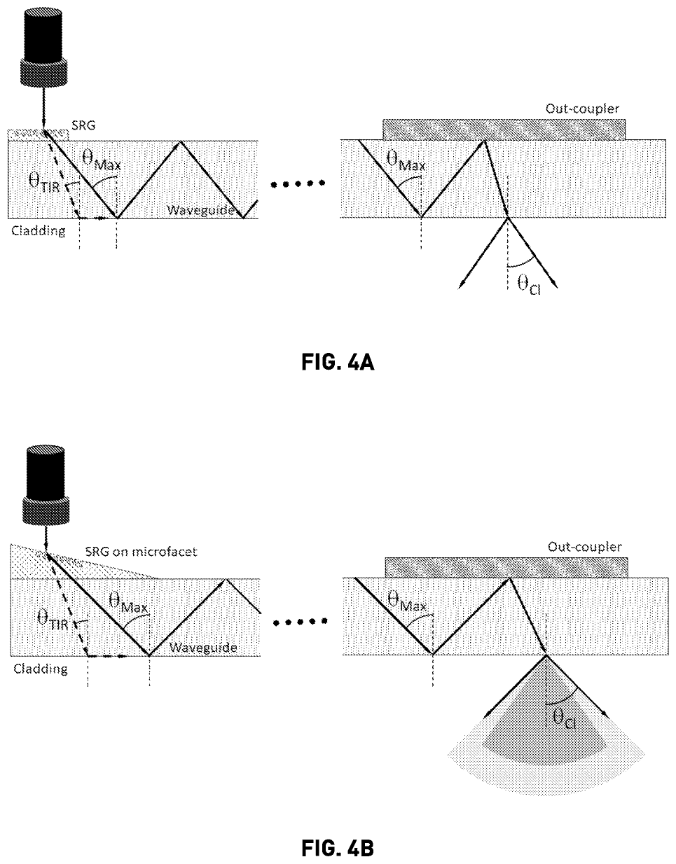

In the case of green light 110 illustrated in FIG. 2B, the diffraction angle θ_{D2} realized for green light 110 using the same slanted grating shown in FIG. 2A. In the illustrated example, the diffraction angle θ_{D2} realized for the green light 110 is still large enough to satisfy the TIR condition, which is dictated by index contrast (Δn=n₂−n₁). In addition to the TIR condition, there is also an angular bandwidth condition that determines optimal performance, and this angular bandwidth condition discussed below with reference to FIGS. 4A and 4B, for example. The diffraction angle θ_{D2} can be increased by decreasing the pitch d. When the red light 112, green light 110, and blue light 108 are each coupled into separate waveguides using separate in-couplers 102, then the parameters of each of the respective in-couplers 102 can be adapted to the corresponding wavelengths.

In the case of blue light 108 illustrated in FIG. 2C, the diffraction angle is smaller for the blue light 108 than for the green light 110, when using the same slanted grating shown in FIGS. 2A and 2B. For the same slanted grating, the diffraction angles have the following relation θ_{D1}<θ_{D2}<θ_{D3}. The diffraction angle shown in FIG. 2C for the blue light 108 is too small to satisfy the TIR condition. The in-coupler 102 disclosed herein (e.g., but not limited, the in-coupler 102 illustrated in FIGS. 3A-3C, 4B, 5A-5E, 7, and 8) corrects this issue by using a refractive element to increase the steering angle.

Common transparent materials used for fabricating the core 114 of the waveguides have refractive indices ranging from about 1.3 to about 2 in the visible spectrum. The materials used to surround the core 114 of the waveguide (e.g., but not limited to, the cladding) have a refractive index in the range from about 1 to about 1.5 (e.g., air has an index of refraction that is about 1 and regular resin has an index of refraction that is about 1.5). Consequently, the index contrast Δn=n₂−n₁ can be in the range from about 0.1 to about 1. This range of index contrasts corresponds to TIR angles that range from about 30 to about 89 degrees.

Indexing matching between the in-coupler 102 and the core 114 can be achieved by selecting a resin to fabricate the in-coupler 102 that has a refractive index that approximately matches or matches that of the core 114, thereby avoiding Fresnel reflections from the interface between the core 114 and the in-coupler 102. Consequently, the materials used for fabricating the in-coupler 102 can have an index of refraction in the range from about 1.2 to about 2. For a transmissive in-coupler 102, a low haze value of the resin material is useful to ensure sec-through capability, enabling augmented reality application. Haze values for materials used for fabricating the in-coupler 102 and core 114 can be less than about % 0.1.

The grating pitch d of the in-coupler 102, is in a range from about 300 nm to about 1000 nm, or between about 400 nm and about 700 nm. The duty cycle of the grating (i.e., the percentage of pitch spanned by the high index material) is between about 30% to about 80%, or between about 50% and about 70%. The slanted grating angle is in a range from about 20 degrees to about 70 degrees.

The in-coupler 102 of FIG. 1 depicted in FIGS. 3A-3C includes both a refractive element and a diffractive element. In this non-limiting example, the refractive element is a wedge-shaped dielectric (e.g., but not limited to, a microfacet) with index of refraction n_{ic}, and the diffractive element is the slanted grating on the front face of the dielectric wedge. The dielectric wedge is illustrated as having a triangular shape, but a quadrilateral shape (e.g., but not limited to, a right-angle trapezoid) can also be used to change the angle of the optical axis use refraction. Using both refraction and diffraction to cause respective changes in the angle of the optical axis results in a larger steering/deflection angle than using either refraction or diffraction alone.

Although the diffraction angle can be increased by changing the pitch d, for example, there can be a tradeoff between diffraction angle and coupling efficiency, such that increasing the diffraction angle for a particular order of diffraction decrease the percentage of light coupled into that particular order of diffraction. Thus, rather than increase the diffraction angle to achieve a predetermined steering/deflection angle, the diffraction angle can be chosen to have a predetermined coupling efficiency and refraction can be used to make up the difference between the diffraction angle and the desired steering angle.

Further, the steering/deflection angle due to diffraction, alone, results in the following relation θ_{D1}<θ_{D2}<θ_{D3} for the blue light 108, green light 110, and red light 112, respectively. Assuming normal dispersion, the opposite relationship holds for the steering/deflection angle due to refraction alone because the refraction angle is proportional to the index of refraction and n_{ic}(λ_{red})<n_{ic} (λ_{green})<n_{ic} (λ_{blue}) for normal dispersion. Thus, as a function of wavelength, the change in the steering/deflection angle due to diffraction is at least partially offset by the change due to refraction. The relation θ_{D1}<θ_{D2}<θ_{D3} for diffraction can be restated as the change in the direction of the optical axis arising from diffraction is greater for longer visible wavelengths (e.g., but not limited to, red light 112) than for shorter visible wavelengths (e.g., but not limited to, the blue light 108). The relation for refraction for normal dispersion can be restated as the change in the direction of the optical axis arising from refraction is less for longer visible wavelengths (e.g., but not limited to, red light 112) than for shorter visible wavelengths (e.g., but not limited to, the blue light 108).

The in-coupler 102 illustrated in FIG. 3A is a combination of a refractive element 302 (e.g., but not limited to, an angled microfacet) and a diffractive element 304 (e.g., but not limited to, a grating). This non-limiting example illustrates how a microfacet, which uses refraction to change the light direction, is combined with a grating, which uses diffraction to change the light direction, for a combined structure that enables a large steering angle with high-efficiency coupling.

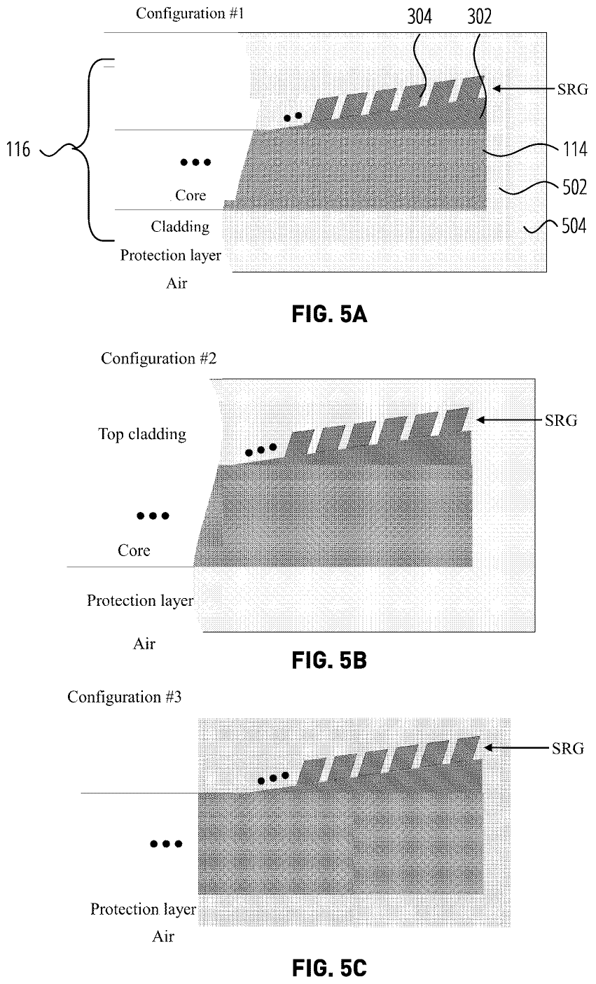

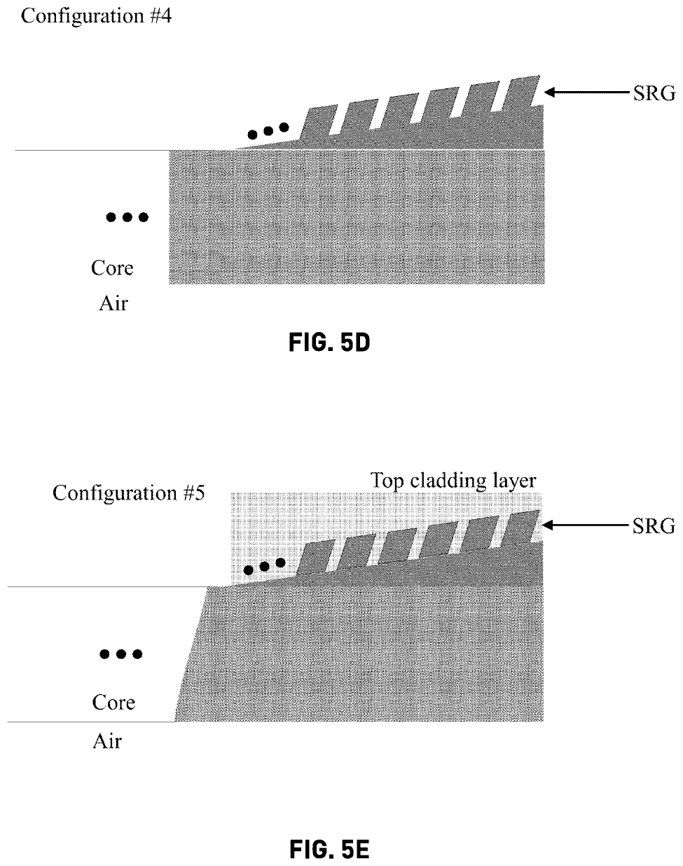

In this non-limiting example, the parameters of the diffraction grating are selected for a condition where the orientation of the grating is rotated due to being arranged along the angled front face of the microfacet. Additional discussion of the orientation of the grating being rotated by the angle of the front face of the microfacet is provided below with reference to FIGS. 5A-5E, 6A, 6B, 7, and 8.

Considered separately, each of the diffractive element 304 and the refractive element 302 will change the direction of the optical axis of the incoming light. On the one hand, the diffractive element 304 (i.e., the grating) without the refractive element 302 (i.e., the underlaid microstructure) changes the optical axis of the incoming light by a diffraction angle, as discussed above with respect to FIGS. 2A-2C. On the other hand, the refractive element 302 without the diffractive element 304 results in refraction that changes the direction of the optical axis of the incoming light by an amount that depends on the angle of the microfacet structure θ_{TFS} and the index of refraction n_{ic}. For example, based on Snell's law, the change in angle due to refraction OR for the configuration shown in FIG. 3A is given by

$${θ}_{R} = {sin}^{- 1} ( \frac{{n}_{ic}}{{n}_{1}} sin ( {θ}_{TFS} ) ) - {θ}_{TFS} .$$

By using both refraction and diffraction to achieve the desired steering angle, more degrees of freedom are available for optimizing the design of the in-coupler 102. For example, after accounting for the steering angle resulting due to refraction by a microfacet, the parameters of the diffraction grating can be selected to further steer the beam toward the desired propagation angle in the waveguide. When the grating is combined with the microfacet structure, the combined structure steers the beam into the target steering angle while maintaining a high coupling and diffraction efficiency. The microfacet enables higher-efficiency steering capability and adds another degree of freedom for designing the in-coupler 102 for the waveguide 116.

The modified steering angle θ′_{D3} combining the angle changes induced for the red light 112 due to both refractive element 302 and the diffractive element 304 are shown in FIG. 3A. As in the purely diffractive case illustrated in FIG. 2A, the induced steering angle of the red light 112 is sufficient to satisfy the TIR condition.

The modified steering angle θ′_{D2} combining the angle changes induced for the green light 110 due to both refractive element 302 and the diffractive element 304 are shown in FIG. 3B. As in the purely diffractive case illustrated in FIG. 2B, the induced steering angle of the green light 110 is sufficient to satisfy the TIR condition.

The modified steering angle θ′_{D2} shown in FIG. 3B illustrates how a larger steering angle (i.e., θ′_{D2}>θ_{D2}) with acceptable efficiency is enabled by combining the refractive element 302 (e.g., but not limited to, a microfacet) with the diffractive element 304 (e.g., but not limited to, a diffraction grating, such as a transmissive slanted grating). Here, adding the microfacet enables another degree of freedom to steer the light more efficiently toward the desired direction. Considering the case shown in FIG. 2B, in which the green light 110 was diffracted to a small steering angle, adding the microfacet enables higher efficiency coupling into a larger steering angle, as discussed above. Although, the desired steering angle θ′_{D2} can be realized by decreasing smaller pitch d to a smaller pitch d instead of the adding the refractive element 302, the smaller pitch d is likely to decrease the coupling efficiency, and the size of this decrease in the coupling efficiency can be significant depending on the refractive index contrast Δn between the waveguide and surroundings.

The modified steering angle θ′_{D1} for the blue light 108 due to both refractive element 302 and the diffractive element 304 are shown in FIG. 3C. In contrast to the purely diffractive case illustrated in FIG. 2C, here the induced steering angle of the blue light 108 is sufficient to satisfy the TIR condition.

Whereas in FIG. 2C the steering angle θ′_{D1} induced by diffraction alone was insufficient to satisfy the TIR condition resulting from the low index contrast Δn, the additional contribution to the modified steering angle θ′_{D1} arising from the addition of the refractive element 302 increases the modified steering angle θ′_{D1} enough to satisfy the TIR condition. That is, in FIG. 2C, the blue light 108 did not satisfy the TIR condition since the pitch value was not small enough to steer the beam to a larger angle suggested by the large TIR angle resulting from a low index contrast. As discussed above for FIG. 3B, adding the microfacet allows a larger steering angle with higher efficiency and more degrees of freedom for optimizing the design. Thus, combing the microfacet with diffraction grating facilitates satisfying the TIR conditions and enabling efficient steering angles, thereby overcoming various design challenges such as the challenges resulting from the low refractive index contrasts (Δn=n₂−n₁).

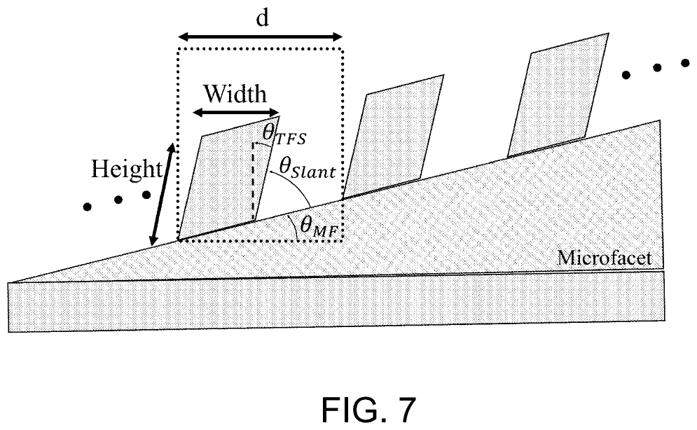

The diffractive element 304 is illustrated in FIGS. 3A-3C using a non-limiting example of slanted gratings. Apart from the above discussion related to selecting a value for the pitch d, the above discussion has not fully addressed the factors influencing the selection of parameters for the slanted gratings, including factors, such as the slant angle and depth of the gratings. The design process of the slanted grating is discussed more fully below with reference to FIGS. 7-9. The parameters of the slanted gratings are selected and/or optimized to provide a diffraction efficiency of the slanted grating that is large enough to couple a substantial portion of the incident light power into the fundamental diffraction order. In the case of slanted gratings, the diffraction efficiency of the fundamental order is dependent on the angle of incidence, thus the facet angle of the microstructure helps optimize the efficiency and lower the optical power coupled into the higher diffraction orders. The higher diffraction orders cause ghost images of the primary image, thus optimizing the coupling efficiency is useful to mitigate ghosting in addition to being useful for maintaining the overall system efficiency.

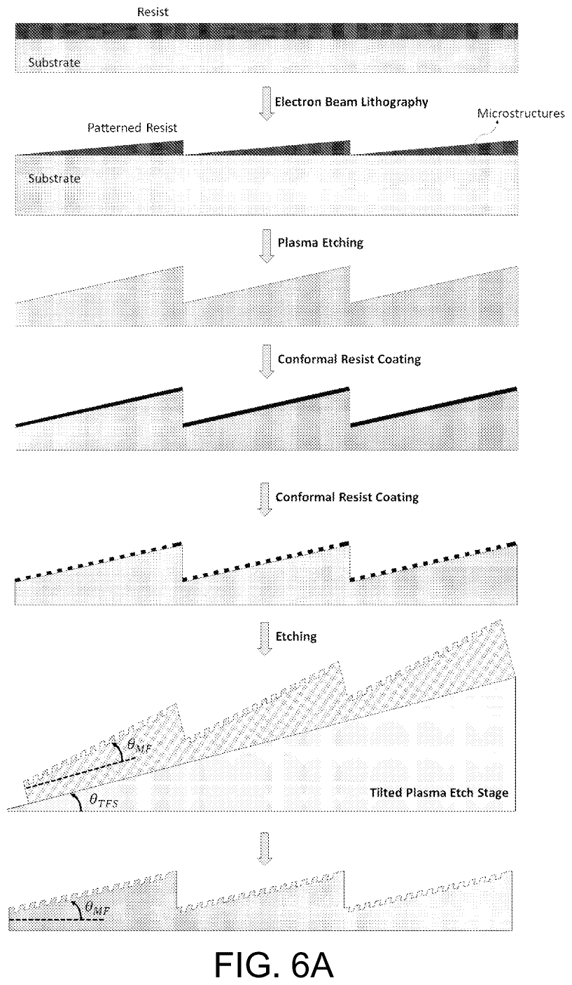

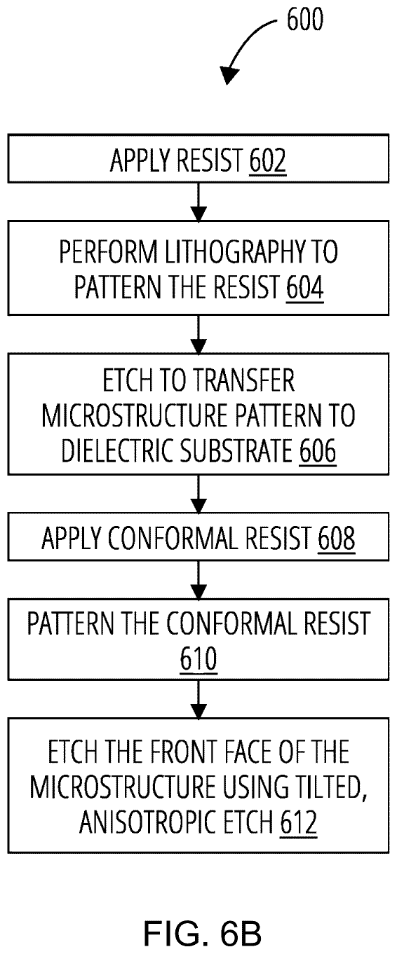

The characteristic length D of the microstructure shown in FIG. 3B, is shown as a length of the microstructure along the interface with the waveguide. The microstructure then repeats, as illustrated in FIG. 6A. For example, the microstructure can be periodic with the period given by the characteristic length D, or the microstructure can be aperiodic (e.g., have a random width) and the characteristic length D can be the average width of the microstructure. Randomizing the width of the microstructure minimizes diffraction effects due to the microstructure by randomizing the coherent interference that gives rise to the diffraction effect.

The effects of diffraction from the refractive element 302 can be mitigated by selecting the characteristic length D to be much larger (e.g., but not limited to, four time larger) than the pitch d of the diffractive element 304.

Additionally, the total diffracted power due to the periodic array of microstructures is likely to be small as evidenced by the similarity of the array of microstructures to blazed diffractive elements with large periodicity. Because blazed diffractive elements with large periodicity generally have a low transmissive coupling efficiency (e.g., much lower transmissive coupling efficiency than the nanostructured slanted gratings) the array of microstructures are similarly anticipated to have low transmissive coupling efficiency, which is confirmed through numerical simulations.

The material parameters for the in-coupler 102 and waveguide 116 in FIGS. 3A-3C can be the same as those in FIGS. 2A-2C. For example, the materials used for fabricating the core 114 of the waveguide 116 can have refractive indices n₂ ranging from about 1.3 to about 2 in the visible spectrum. The materials used to surround the core 114 of the waveguide (e.g., the cladding) have a refractive index n₁ in the range from about 1 to about 1.5 (e.g., air has an index of refraction that is about 1 and regular resin has an index of refraction that is about 1.5). Consequently, the index contrast Δn=n₂−n₁ can be in the range from about 0.1 to about 1. This range of index contrasts corresponds to TIR angles that range from about 30 degrees to about 89 degrees.

The refractive index n_{ic} of the resin used to fabricate the in-coupler 102 matches that of the core 114, thereby avoiding Fresnel reflections from the interface between the core 114 and the in-coupler 102. Consequently, the materials used for fabricating the in-coupler 102 can range from about 1.2 to about 2. For a transmissive in-coupler 102, a low haze value (e.g., but not limited to, less than about 0.1%) of the resin material is useful to ensure see-through capability, enabling augmented reality application. Haze values for materials used for fabricating the in-coupler 102 and core 114 are less than about 0.1%.

Although other diffraction gratings are contemplated and fall within the scope of the disclosure, the non-limiting examples used herein to illustrate the in-coupler 102 use schematic diagrams and calculations for a transmissive grating where the transmissive slanted grating can be placed on a microfacet to enable an additional degree of freedom in the design and fabrication of an in-coupler 102. In addition to transmissive gratings, reflective diffraction gratings are contemplated and can be used for the in-coupler 102. Also, the diffractive element 304 that is combing the refractive element 302 is illustrated using the non-limiting example of a grating. A person of ordinary skill in the art will understand that other diffractive element 304 can be used to steer the angle of the incoming light, including, e.g., but not limited to, blazed gratings, binary gratings, slanted gratings, and phase gradient metasurfaces (PGM).

The TIR condition (discussed above) and the angular-bandwidth condition inform the selection of parameters for the in-coupler 102 and waveguide 116. The angular-bandwidth condition includes the beneficial effect of the using a refractive element 302 in the in-coupler 102, as illustrated FIGS. 4A and 4B. The influence of using microfacets on the FOV of a general waveguide system with a fixed acceptable input coupling efficiency is illustrated in FIGS. 4A and 4B. By comparing the angular bandwidth in FIG. 4A for the in-coupler 102 without the microfacet with that in FIG. 4B for the in-coupler 102 with the microfacet, it is observed that the system with the microfacet provides improved angular bandwidth. Coupling systems that have different configurations for the in-coupler 102, but the systems are otherwise identical, are shown in FIGS. 4A and 4B. That is, each system has an identical beam expander and an identical out-coupler. The in-coupler 102 in FIG. 4A is a slanted surface relief grating and the in-coupler 102 in FIG. 4B is a slanted surface relief grating conformed onto a front surface of a microfacet. In these embodiments, it is assumed that the waveguide 116 has a low index contrast (e.g., but not limited to, Δn<1) due to the core 114 being encompassed by a cladding having refractive index that is close to that of the core 114.

The field of view (FOV) of a waveguide combiner in near-eye-displays is determined by the maximum diffraction angle θ_{Max} and the TIR angle:

$$FOV = 2 {θ}_{cl} = 2 {sin}^{- 1} [ \frac{1}{2} ( \frac{{n}_{2} sin ( {θ}_{Max} )}{{n}_{1}} - 1 ) ] ,$$

where θ_{cl} and θ_{Max} are shown/defined in FIGS. 4A and 4B, and the indices of refraction for the core and cladding of the waveguide are respectively n₂ and n₁.

Assuming that the minimum acceptable diffraction angle is θₘᵢₙ=θ_{TIR} where θ_{TIR} is the TIR angle (also referred to as the “critical angle”). In the FOV equation above, θ_{cl} is the angle of out-coupled beam, and θ_{Max} is the maximum angle of diffraction in the in-coupler at which the targeted diffraction efficiency (or in-coupling efficiency) for the fundamental diffraction order can be achieved.

The FOV is essentially determined by θ_{Max} for a fixed refractive index combination, as shown in FIG. 4A. The maximum angle θ_{Max} in a slanted grating can be primarily determined by the pitch d of the grating periodicity, and therefore by careful selecting the value of the pitch d the grating can be optimized to provide a desired maximum angle θ_{Max}.

An in-coupler 102 having a slanted grating conformed on a microfacet is shown in FIG. 4B, and this in-coupler 102 couples the incident light into the waveguide 116. Utilizing the refraction angle provided by the microfacet, θ_{Max} can be increased to be larger than the θ_{Max} in FIG. 4A, while maintaining the targeted in-coupling efficiency, resulting in a large angular field of view. The above example comparing FIGS. 4A and 4B is for a single wavelength of light, but the concepts generalize and apply to all primary color wavelengths, including the red light 112, green light 110, and blue light 108.

Non-limiting, example configurations of the waveguide 116 are provided in FIGS. 5A-5E. These show how the core 114, cladding 502, and protective layer 504 can be arranged, and are illustrative of the many possible configurations that can be used together with the in-coupler 102 disclosed herein. The in-coupler 102 and the layers of the waveguide 116 parts can have the same or different indices of refraction in the respective configurations.

Generally, the waveguide 116 provides guiding of the light by surrounding the higher-index core 114 with a lower-index medium, which can be a cladding 502, a protective layer 504, or air. Often, the main components, such as the in-coupler 102 and core 114 are sandwiched between the cladding 502 and a protective layer 504, as shown for configuration #1 in FIG. 5A. The sandwiched structure can then be surrounded by air, for example. The cladding 502 can have a low refractive index to increase the refractive-index contrast Δn, resulting in a smaller TIR angle or a larger angular bandwidth for the FOV.

In configuration #2, the cladding 502 can be arranged at the top of the waveguide 116, and protective layer 504 at the bottom of the waveguide 116 can act as a lower cladding, as shown in FIG. 5B. The cladding 502 and the protective layer 504 can be fabricated using different materials around the in-coupler area. Configuration #2 can be desirable for at least two reasons: 1) configuration #2 can be easier to fabricate due to limitations in the fabrication process and 2) configuration #2 can improve performance of the grating by allowing for a more favorable difference in the refractive indices between the in-coupler 102 and the cladding 502. In configuration #2, the waveguide part can be surrounded by the protective layer 504 that acts as both a cladding (on the bottom) and provides protection.

In configuration #3, the protective layer 504 acts as the cladding both on top and on the bottom of the core 114, as shown in FIG. 5C. That is one layer encapsulates the waveguide 116 and the in-coupler 102 area. This encapsulating protective layer 504 acts as both a protection and cladding.

Configuration #4 provides a maximum refractive index contrast by using air, which has an index of refraction of about 1 to surround the core 114 of the waveguide and the in-coupler 102, as shown in FIG. 5D. In this configuration, the presented embodiment would add another degree of freedom to the design parameters to satisfy the maximum efficiency at the desired steering angle.

Configuration #5 provides a cladding 502 only over the in-coupler 102, but otherwise the core 114 is surrounded by air, as shown in FIG. 5D. Thus, configuration #5 combines aspects of configuration #2 with aspects of configuration #4 (e.g., a cladding material is provided in proximity to the in-coupler 102, and the waveguide takes advantage of the maximum refractive index contrast offered by the air interface.

A schematic illustration of various step in the fabrication process 600 of a stamp used for producing the in-coupler 102 is shown in FIG. 6A. Various steps of the fabrication process 600 are shown in the flow diagram provided in FIG. 6B. After the stamp is fabricated, the stamp can be used to nanoimprint the micro and nanostructures onto thermoplastic or UV curable resin via molding, nanoimprinting, and demolding processes.

The simplified fabrication process of the stamp used for producing the in-coupler 102 discussed above is shown in FIG. 6A. The dimensions and angles fabricated in the stamp are significant because they determine the parameters, angles, and duty cycle of the microstructure and SRG gratings, for example.

An example flow diagram for the fabrication process 600 of a stamp used for producing the in-coupler 102 is illustrated in FIG. 6B. Although the exemplary routine depicts a particular sequence of operations, the sequence may be altered without departing from the scope of the present disclosure. For example, some of the operations depicted may be performed in parallel or in a different sequence that does not materially affect the function of the routine. In other examples, different components of an exemplary device or system that implements the routine may perform functions at substantially the same time or in a specific sequence.

In step 602 of the fabrication process 600, a resist is applied to a substrate. For example, the fabrication process 600 starts with coating a substrate (e.g., but not limited to, a silicon, quartz, or sapphire wafer) with a thin layer (e.g., but not limited to, up to 2 μm) of electron-beam resist.

In step 604 of the fabrication process 600, lithography is performed to pattern the resist. For example, using gray-scale electron beam lithography, the electron beam resist is patterned into tilted microstructures. According to certain non-limiting examples, to implement the gray-scale lithography, the contrast curve of the electron-beam resist is extracted and the resist height as a function of electron beam dose is derived. The desired profile (e.g., but not limited to, a saw-tooth profile or a piecewise tilted profile with peak resist height of about 400 nm and a characteristic length D as discussed above) is patterned onto the electron-beam resist. The resist may undergo a thermal resist reflow process to smooth the surface profile of the micro-patterned structure after chemical development.

In step 606 of the fabrication process 600, According to some examples, an etch is performed to transfer the pattern of the resist to the substrate thereby providing the microstructure pattern. For example, the patterned resist is etched using an anisotropic dry etching process to transfer the shape of microstructures onto the underlaid substrate. The height of the transferred microstructures may be taller than the that of the microstructures on the resist depending on the selectivity of the etch process, defined as the ratio between the etch rate of the substrate and the etch rate of the resist. The selectivity is adjusted to acquire the targeted microfacet angle.

In step 608 of the fabrication process 600, a conformal resist is applied to conform to a front surface of the microstructure of the stamp. For example, the surface of the microstructure can be coated with a thin layer of resist (e.g., but not limited to, up to 1 μm, or less than about 400 nm) using imprinting. According to certain non-limiting examples, an electron beam resist is spun onto a surface treated wafer coated with an epoxy resin (e.g., but not limited to, thermal resin) and pressed onto micro-patterned substrate to transfer the resist layer onto the micro-patterned substrate. This process provides a uniform thickness of the resist on the microfacets. This resist may be similar or different than the electron beam resist employed to pattern the microstructures.

In step 610 of the fabrication process 600, portions of the conformal resist is patterned to expose the substrate so that the substrate can be etched to form the pattern of the gratings. For example, the resist is patterned using binary electron beam lithography to create openings. The openings can be directly used in the following dry etching step to form slanted nanostructures on the microstructures, or the openings in the patterned resist can be used to define a hard mask and openings in the hard mask can be used for the following etching step. For example, to create a hard mask, a thin film of metal or oxide that provides a reasonably large selectivity is deposited onto the resist, and where openings are desired, the material is lifted off to create openings and where no material is lifted off the remaining material provides hard mask islands to prevent etching where the islands are. In either case, the slanted grating is formed by placing the resist-coated or the hard-mask coated substrate on a tilted stage and the applying anisotropic etching to form the targeted slanted patterns, as discussed next.

In step 612 of the fabrication process 600, an etch is performed to generate the nanostructure of the grating by removing material from regions in the substrate where the conformal resist has been previously removed. For example, the slant angle of the gratings is achieved by tilting the direction of the substrate by an angle θ_{TFS} with respect to the direction of the anisotropic etch (e.g., but not limited to, a tilted plasma etch).

Finally, the resist is removed and the final stamp, which is shown on the bottom of FIG. 6B can be used to nanoimprint thermoplastic or UV curable resin with the microstructures and nanostructures of the microfacets and SRG gratings, respectively. Transferring these structures from the stamp to thermoplastic or UV curable resin can be realized via molding, nanoimprinting, and demolding processes.

These microstructures and nanostructures are the negatives of the front surface of the in-coupler 102. The negative of the front surface of the in-coupler 102 has material where there is a void in the in-coupler 120, and the negative of the in-coupler 102 has a void where the in-coupler 102 has material, such that applying the stamp to a castable medium results in the shape of the front surface of the in-coupler 102. Because the stamp is the negative of the in-coupler 102, the microstructure of the stamp has the same microfacet angle θ_{MF} as the microfacets of the in-coupler 102. Also, the nanostructure of the stamp has the same pitch d and tilt angle θ_{TFS} as the grating of the in-coupler 102, but the duty cycle of the stamp is opposite the grating (e.g., a duty cycle of 40% for the stamp corresponds to a duty cycle of about 60% for the grating. Thus, the angles and dimensions may need only be specified for either the stamp or for the front face of the in-coupler 102 because specifying one uniquely constrains the other.

Various ranges of angles can be used to fabricate the microstructures and nanostructures of the stamp. The tilted fabrication performed in step 612 applies an anisotropic etch using a tilt angle θ_{TFS}, which can be in the range of about 20 degrees to about 70 degrees. The microfacet angle θ_{MF} can be in a range of range from about 2 degrees to about 70 degrees; or can be in a range of in the range of range of about 2 degrees to about 45 degrees; or can be in a range of in the range of about 2 degrees to about 20 degrees. The characteristic length D of the microstructure can be in a range of about 1 μm to about 72 μm; or can be in a range of about 4 μm to about 64 μm; or can be in a range of about 8 μm to about 40 μm.

Periodic microstructures with a comparatively small pitch can be avoided because they can have highly efficient diffraction of the fundamental order interfering with the desired diffraction of the overlaid slanted gratings.

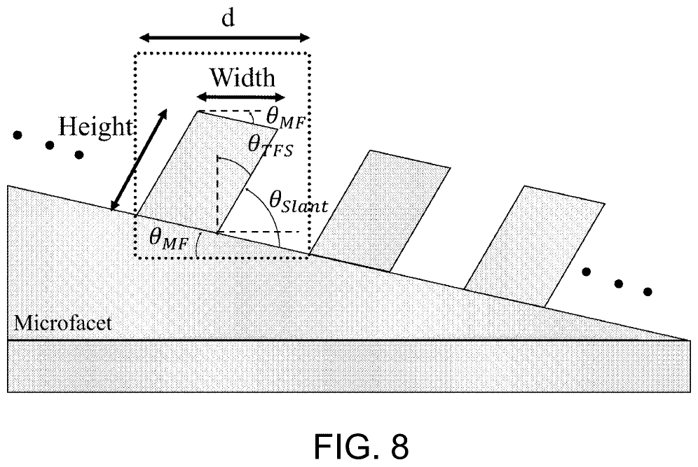

Simplified schematics showing the unit structure of a slanted grating pm the microfacets are shown in FIGS. 7 and 8. The slant angle θ_{Slant} of the grating with respect to front face of the microfacet is counterclockwise according to convention. In FIGS. 7 and 8, the main parameters that can be used to optimize the performance of the in-coupler 102 are shown for a unit cell of the microfacet with the pitch d for the grating. The width and height variables represent the dimension of each segment forming the slanted grating. The duty cycle is given by the ratio (Width×cos (θ_{MF})/d.

The parameters and degrees of freedom that can be used in one example (i.e., the example in which both angles θ_{MF} and θ_{Slant} are in counterclockwise direction) for optimizing a slanted grating on microfacet are shown in FIG. 7.

In this arrangement, the slant angle is given by θₛₗₐₙₜ=90-θ_{TFS}−θ_{MF}, where θ_{TFS} is the angle for the tilted etching stage, as shown near the bottom of FIG. 6A and θ_{MF} is the microfacet angle. The refraction due to the microfacet is used to increase the efficiency of the large steering angle, and the larger steering angle satisfies the TIR condition. These angles also provide additional degrees of freedom for optimizing efficient beam steering using the in-coupler 102.

FIG. 8 shows an alternative example in which the angle θ_{MF} is in clockwise direction, and the angle θ_{Slant} is in counterclockwise direction. FIG. 8 shows the parameters and degrees of freedom used in optimizing a slanted grating on microfacet for this case. y.

In this arrangement, the slant angle is given by θₛₗₐₙₜ=90−θTFS−θ_{MF}. This configuration provides another degree of freedom for optimizing the slanted angle.

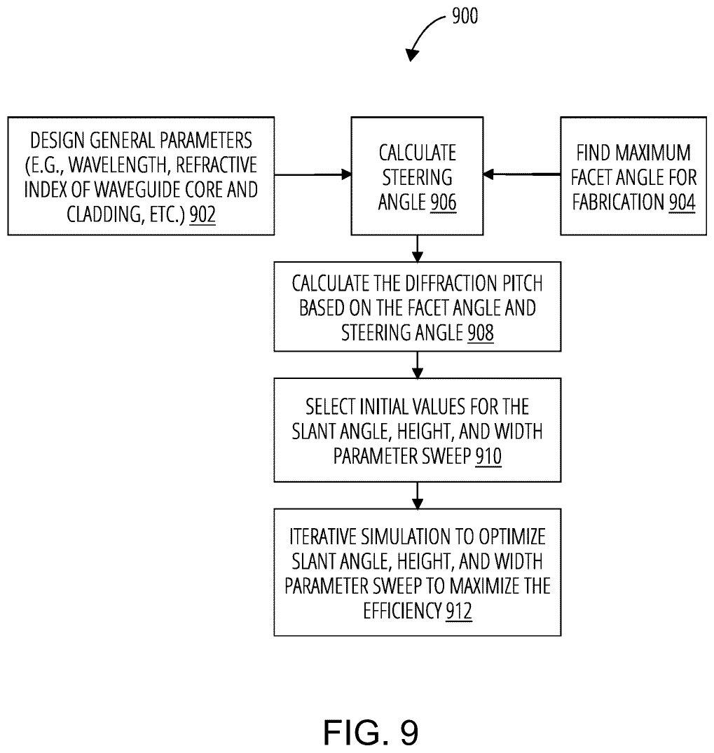

A flow diagram of process 900 for optimizing the parameters of the in-coupler 102 is provided in FIG. 9. Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence.

In step 902 of process 900, According to some examples, the general parameters of the waveguide 116 are selected. These parameters can include, e.g., but not limited to, wavelength, refractive index of waveguide core and cladding. For example, step 902 can include specifying a list of system parameters, such as refractive indices of the core 114, cladding 502, and other layers, as well as the design wavelength.

In step 904 of process 900, the maximum facet angle for fabrication are found. For example, the angle range of microfacets that can be fabricated and processed can be set in step 904.

In step 906 of process 900, the steering angle is calculated. For example, the steering angle that is desired to satisfy the TIR condition and the angular-bandwidth condition can be calculated based on the parameters determined in step 902 and step 904.

In step 908 of process 900, according to some examples, the method includes the pitch d of the diffractive element 304 is calculated based on the angle of the microfacet and based on the steering angle.

In step 910 of process 900, the remaining parameters that are used for numerically simulating the performance of the in-coupler 102 are initialized. For example, initial values can be selected for the parameters shown in FIGS. 7 and 8, such as the slant angle, height, and width. Further a range of values and steps size can be set for a parameter sweep performed in a series of numerical simulations.

In step 912 of process 900, a series of numerical simulations are performed to determine the optimal values for the slant angle, height, and width that provide the best performance for the in-coupler 102 e.g., but not limited to, optimizing the coupling efficiency and/or angular bandwidth at the out-coupler 104). Step 912 can include iterative simulation to optimize slant angle, height, and width parameter sweep to maximize the efficiency at step 912.

For example, a Finite-Difference Time-Domain (FDTD) simulation can be used to rigorously analyze the initially selected parameters of the in-coupler 102. FDTD simulations can be used to execute parameter sweeps to find the optimum values for the parameters, which results in steering angle and corresponding configuration having the maximum coupling efficiency. These simulations and the search for the optimal parameter values can be constrained based on the fabrication capabilities.

According to certain non-limiting example, the initial parameters can be set to have an acceptable fill factor for the simulation cell. Then, using the fill factor value, the Height parameter of the slanted grating can be calculated for a certain Width value, where the Height and Width are defined as illustrated in FIGS. 7 and 8. The optimum slant angle and width that maximizes the coupling efficiency can then be determined. To simulate slanted grating on the microfacet, the cell containing the slanted grating structure with no microfacet can be simulated using incoming light with a tilted angle equivalent to the one exposed by the microfacet.

To illustrate changes in the selection of the pitch d of the in-coupler 102 due to the microfacet angle θ_{MF}, consider the case when and the incoming light is at a normal incidence angle. In this case the value of the pitch d is straightforward to select because the light in normal to the gratings. However, adding the microfacet under the slanted grating changes the effective incidence angle of incoming light relative to the grating. Therefore, the grating pitch can be altered in accordance with this relative incidence angle. As discussed above, combining the refractive element 302 with the diffractive element 304 allows reducing the diffraction angle because refraction makes up the difference to realize the desired steering angle. Microfacet structures cause refraction to bend the optical axis of the incoming light. Additionally, changing the microfacet angle provides precise adjustment of the tilt angle on top of the slanted grating structure. Changing the angle at the top of the slanted grating structure is demonstrated to broaden the angular response of the slanted grating. Further, the addition of microfacets provides a practical and reliable technique to tune this angle.

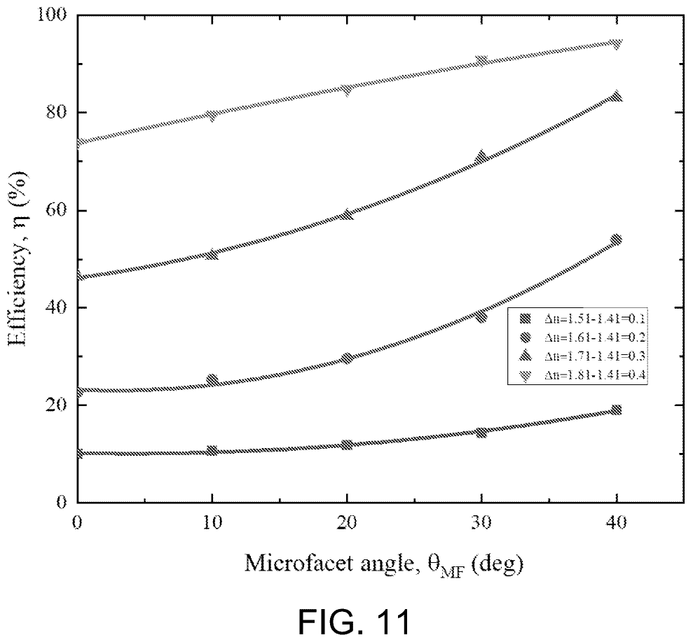

Simulations and calculations were performed to demonstrate the benefits of the in-coupler 102 disclosed herein, and results of these simulations and calculations are shown in FIGS. 10 and 11. Calculated values for the total internal reflection (TIR) angle θ_{TIR} are shown along the vertical axis in FIG. 10 as a function of cladding refractive index (horizontal axis). The curves shown in FIG. 10 are for difference values of the refractive indices of the core 114.

As discussed above, the TIR angle in a waveguide system disclosed herein depends on the refractive index contrast Δn between the refractive index of the core 114 and the refractive index of the cladding (or if the upper and lower cladding are different the larger refractive index of the upper and lower cladding). Various implementations of the waveguide system are shown in FIGS. 5A-5E. Selecting materials for the core 114 and cladding to provide a workable TIR angle θ_{TIR} is a useful step on which the determination of the steering angle may depend. For example, ensuring the average value for the steering angle has a comfortable margin from the TIR angle θ_{TIR} is desired to facilitate a wide angular range of rays. But this becomes increasingly challenging as the TIR angle θ_{TIR} approaches 90 degrees.

As discussed above, a decrease in the refractive index contrast Δn results in an increase in the TIR angle. A smaller refractive index contrast Δn therefore limits the range angles that are supported by the waveguide. Assuming for example, a waveguide system with a cladding index of 1.4. For core refractive indices of 1.5, 1.6, 1.7, and 1.8, the TIR angles are 69, 61, 56, and 51 degrees, respectively, as shown in FIG. 10.

The smallest TIR angles providing the widest angular response (represented in the bottom left corner of FIG. 10) may not be feasible using commercially available materials that can be used in processes that allow for mass-production and cost-effective manufacturing. Accordingly, practical considerations may result in using materials that represented near the center of the FIG. 10 to design a workable in-coupler 102.

Simulated efficiency (vertical axis) as a function of micro-fact angle θ_{MF} (horizontal axis) are shown in FIG. 11. The various curves in FIG. 11 represent a range of material refractive index contrasts. Here, curves are shown for four refractive index contrasts: (i) Δn=0.1; (ii) Δn=0.2; Δn=0.3; and Δn=0.4. The refractive-index values used in the simulation have the benefit of corresponding to commercially available resins that can be used in role-to-role processing. The pitch d of the grating structure used in the simulations was selected to satisfy the minimum steering angle that satisfies the TIR condition.

The simulations were performed using Ansys-Lumerical FDTD software, and were performed for microfacet angles of 0, 10, 20, 30, and 40 degrees. In the simulations, the data points are calculated assuming a 100% fill factor, and the width and slant angle parameters were optimized. The height parameter value was calculated based on the pitch d and width of the structure. The simulated efficiency is given by a ratio of the amount of power steered toward the desired angle over total input power. The polarization of the incoming light was aligned with the slant grating groove direction. The wavelength was specified as 532 nm. The simulations were carried out for the structure shown in FIG. 7. In these FDTD simulations, cells containing the slanted grating structure were exposed to incoming light with a tilted angle equivalent to the one exposed by the microstructure.

The lowest efficiency for each curve occurs when θ_{MF}=0 degree, and the efficiency increase as the microfacet angle θ_{MF} increases. Also, the efficiency increase for larger values of the index contrast Δn because the larger contrast Δn corresponds to smaller steering angles useful to satisfy the TIR condition.

Adding the microfacet for all values of the index contrast Δn shown in FIG. 11 improved the efficiency of coupled light. For instance, for the Δn=0.2, efficiency increased by a factor of 2.37 between θ_{MF}=0 degrees and θ_{MF}=40 degrees. The simulation presented in FIG. 11 shows that the addition of the microfacet to the in-coupler 102 provides another degree of freedom to optimize the coupling efficiency.

Additionally, using microfacets is advantageous for fine-tuning of the slanted angle in the grating structure while maintaining high-efficiency beam steering capabilities. Thus, the optimization of the SRG can be adapted based on possible nanoimprinting and material system limitations imposed due to practical aspects of the fabrication process.

Although certain specific embodiments are described above for instructional purposes, the teachings of this patent document and are not limited to the specific embodiments described above. Accordingly, various modifications, adaptations, and combinations of various features of the described embodiments can be practiced without departing from the scope of the invention as set forth in the claims

What is claimed is:

1. An in-coupler device, comprising:
a waveguide comprising a core having a first index of refraction, the core being adjacent to a neighboring medium having a second index of refraction that is less than the first index of refraction; and
an in-coupling component comprising a diffractive element and a refractive element, wherein:
the diffractive element uses diffraction to induce a first change in a direction of an optical axis of incoming light, and
the refractive element uses refraction to induce a second change in the direction of the optical axis of the incoming light.

2. The in-coupler device of claim 1, wherein a combination of the first change and the second change changes the direction of the incoming light by a steering angle that couples the incoming light into the waveguide.

3. The in-coupler device of claim 1, wherein the diffractive element comprises a transmissive diffraction grating with a pitch d.

4. The in-coupler device of claim 3, wherein the transmissive diffraction grating comprises a surface relief grating having nanostructures that vary an index of refraction with the pitch d.

5. The in-coupler device of claim 4, wherein the pitch d is between about 300 nm and about 1000 nm.

6. The in-coupler device of claim 3, wherein the refractive element comprises an array of microfacets that are dielectric wedges with a characteristic length D that is at least twice as large as the pitch d of the diffractive element.

7. The in-coupler device of claim 6, wherein:
the pitch d is between about 300 nm and about 1000 nm;
a duty cycle of the transmissive diffraction grating is between about 30% and about 80%; and
the characteristic length D is between about 1 μm and about 72 μm.

8. The in-coupler device of claim 7, wherein:
the pitch d is between about 400 nm and about 700 nm; and
the characteristic length D is between about 4 μm and about 64 μm.

9. The in-coupler device of claim 6, wherein a wedge angle of the microfacets is between about 5 degrees and about 60 degrees.

10. The in-coupler device of claim 4, wherein:
the surface relief grating is provided by a periodic grating structure etched in a dielectric on a face of the refractive element; and
the periodic grating structure is a slanted grating with a slant angle between about 20 degrees and about 70 degrees with respective to the face of the refractive element.

11. The in-coupler device of claim 1, wherein:
the first change in the direction of the optical axis is greater for longer visible wavelengths than for shorter visible wavelengths; and
the second change in the direction of the optical axis is less for longer visible wavelengths than for shorter visible wavelengths.

12. A method of making an in-coupler device that comprises a waveguide with a core, a refractive element, and a diffractive element, the method comprising:
providing a core of a waveguide, the core having a first index of refraction and being adjacent to a neighboring medium having a second index of refraction that is less than the first index of refraction;
providing a stamp comprising a microstructure and a nanostructure, the microstructure having a shape of a refractive element of an in-coupling component, and the nanostructure having a shape of a diffractive element of the in-coupling component;
arranging an in-coupler medium adjacent to at least a portion of the core; and
stamping the in-coupler medium with the stamp to imprint a shape of the stamp on the in-coupler medium, thereby providing the in-coupler device.

13. The method of claim 12, further comprising fabricating the stamp by:
patterning a resist coating on a substrate to generate a coated substrate;
etching the coated substrate to transfer a pattern of the patterned resist coating to generate the microstructure on a surface of the substrate;
forming a mask on the microstructured surface of the substrate, the mask having openings that expose the substrate; and
etching the substrate at the openings in the mask to form the nanostructure within the microstructured surface.

14. The method of claim 13, wherein fabricating the stamp further comprises shaping the microstructure on the surface of the substrate to be a negative of microfacets in the in-coupling component, the microstructure being shaped by:
using gray-scale electron beam lithography to pattern a profile shape in the resist, the profile shape being a saw-tooth shape or a piecewise monotonically increasing shape;
reflowing the resist coating to smooth a surface profile of the profile shape to generate the patterned resist; and
etching the patterned resist coating using an anisotropic dry etching process that transfers the profile shape of the patterned resist coating to the substrate, thereby generating a negative of shape of microfacet to be formed in the in-coupling component.

15. The method of claim 12, wherein:
the in-coupler medium, when stamped with the stamp forms an in-coupling component comprising the diffractive element and the refractive element,
the diffractive element uses diffraction to induce a first change in a direction of an optical axis of incoming light, and
the refractive element uses refraction to induce a second change in the direction of the optical axis of the incoming light.

16. The method of claim 15, wherein a combination of the first change with the second change changes the direction of the incoming light by a steering angle that couples the incoming light into the waveguide such that a total internal reflection (TIR) condition of the waveguide is satisfied.

17. The method of claim 15, wherein the diffractive element comprises a surface relief grating comprising nanostructures that vary an index of refraction with a pitch d.

18. The method of claim 17, wherein the refractive element comprises an array of microfacets that are dielectric wedges with a characteristic length D that is at least twice as large as the pitch d of the diffractive element.

19. The method of claim 18, wherein:
the pitch d is between about 400 nm and about 700 nm;
a duty cycle of the surface relief grating is between about 30% and about 80%; and
the characteristic length D is between about 4 μm and about 64 μm.

20. The method of claim 17, wherein:
the surface relief grating is provided by a periodic grating structure in a dielectric on a face of the refractive element; and
the periodic grating structure is a slanted grating with a slant angle between about 20 degrees and about 70 degrees with respective to the face of the refractive element.
